(19) United States
(12) Patent Application Publication
(10) Pub. No.: US 2009/0101532 A1
(43) Pub. Date: Apr. 23, 2009

(54) Tool holder having covers and method of use

(75) Inventor: John R. Huot, Saint Paul, MN (US)

Correspondence Address: MOORE & HANSEN, PLLP, 225 SOUTH SIXTH ST, MINNEAPOLIS, MN, 55402, US

(73) Assignee: Huot Manufacturing Company, Saint Paul, MN (US)

(21) Appl. No.: 11/873,981

(22) Filed: Oct. 17, 2007

(51) Int. Cl. B65D 85/00; B65D 51/16; B65D 51/00; B62B 5/00; B65B 7/28

(52) U.S. Cl. 206/379; 220/367.1; 220/377; 280/29; 53/485

(57) ABSTRACT

A tool holder that may be used for storing and/or transporting tools, such as CNC equipment, and a method of use. The tool holder includes a tray having a plurality of receptacles for storing tools and a cover for at least one of the plurality of receptacles. The cover keeps staged tooling clean and workers safe while increasing efficiency and security. The preferred cover includes a body having a first portion, a second portion, a base extending from the second portion and an indicator to designate the type or condition of the tool. Additionally, most preferably, the first piece is transparent and the second piece is opaque. Preferably, the first piece further includes a vent to reduce moisture buildup within the cover. Alternatively, the preferred cover may be made of a one-piece construction. In preferred embodiments, the cover may be removably secured to the tray with fastening elements.

### BACKGROUND

1. Field of the Invention

The present invention relates generally to a tool holder having a plurality of receptacles, a cover for at least one of the receptacles and methods of using the same. The present invention also relates to covers that can be used in conjunction with tool holders for storing and/or transporting machine tools, such as Computer Numerically Controlled (CNC) tools and the like and methods of using the covers.

2. Description of the Related Art

The use of high performance CNC tools and other sophisticated machine tools has increased over the years, spurred by the inherent efficiencies realizable by using these devices. When manufacturing with such machine tools, it is often necessary to have many tools quickly available to fulfill a series of different operations and to perhaps move the tools from one machine to the next for different types of machining operations. The tools machine required for these operations are often quite large, expensive and have extremely sharp working portions. Therefore, there is a strong interest in both protecting the tools as well as protecting workers who work near these types of tools.

Known methods of storing and moving tools include placing or securing the tools on a portable cart with the working portion of the tool facing upwards. The carts generally have a plurality of receptacles to accommodate multiple tools.

The present invention provides improvements to the prior art devices for storing machine tools and methods used to accomplish the same.

### SUMMARY OF THE INVENTION

The present invention provides a tool holder having at least one tray, the tray having a plurality of receptacles for storing machine tools. In preferred embodiments, the tool holder is a cart that is easily transportable. The tool holder further includes at least one cover for one of the receptacles. The cover of the present invention keeps staged tooling clean and workers safe, while increasing efficiency. The preferred cover includes a body having a first portion and a second portion, the second portion having a base. The body may be made of a single-piece construction or molding having one portion, but this is likely much more expensive as larger molds are required for larger single piece covers. Most preferably, the body is two pieces joined together, wherein the first portion includes a vent to reduce moisture buildup within the cover. Making two piece covers, the second portion, which has a base, and is, therefore a somewhat more complicated structure, requiring a more complicated mold.

Preferred embodiments, this portion will be made in one size and the first portion may be made in several sizes so that a series of two-piece covers, joining variously sized first portions, can be assembled to the one sized second portion, in order to make the series of differently sized fully assembled two-piece covers more economically than might be expected if a single piece construction was employed.

In order to prevent machine tools from falling off of the cart, known methods of securing such tools have been used, such as setting the tool in the receptacle provided to receive and retain the tool and anchoring the tool onto the cart with screws. This latter method is burdensome, since it requires the operator to detach the screws in order to remove the tool from the cart and neither method affords protection for exposed portions of the tools from colliding with moving objects in the work area or for workers from sharp edges or hot surfaces on the exposed portions of the tools.

Known tool holders also fail to reduce or limit the opportunity for industrial espionage. As known tool holders and methods do not mask the tools, anyone in the area where the tools are located and in view may see what types of tools are being used for each project. To address this problem, some machine operators have resorted to shrouding exposed portions of the tools with packaging materials while the tool is located in a receptacle on the cart. This informal method of hiding tools has many drawbacks. For example, the packaging material cannot be secured to the cart making its safety effectiveness questionable. Additionally, the packaging material is generally opaque, so the workers cannot see the exposed portion of the tool and, moisture can build up in the packaging material, which can damage the tool or require the worker to clean the tool prior to use.

The present inventor appreciates that a tool holder having a device for protecting the machine tools and the machine operators who work near the stored tools is advantageous for many reasons. The inventor also appreciates that a device that conceals the tools from visitors, yet provides for quick identification by workers during machine setups is also advantageous. The present inventor also appreciates that if such a device can be provided economically, to users, this will also be advantageous.

Once a tool is inserted in the receptacle such that a working portion of the tool is facing upwards, the cover may be placed over the tool to protect both the tool and anyone near the tool holder. In the preferred embodiments, the cover is then removably secured to the tray with fastening elements such as magnets, removable adhesive or key hole slots that secure to threaded bolts or the like fastened to the tray or other fastening elements.

The preferred cover will have a second portion that is opaque. An opaque second portion will tend to mask the tool inside and will be effective in reducing the success of industrial espionage, as one cannot determine which types of tools are being used for a project without knowledge of which tools are used. Preferably, the first portion is substantially transparent so that a portion of each tool within the cover may be quickly identified by a worker at a close distance. It is further contemplated that, in alternate embodiments, the first portion could have an identifier, such as a colored tint, to designate, for example, the type or condition of the tool. In other alternate embodiments, at least part of the cover is made of a material that may be marked with a dry erase marker or grease pencil such that erasable/modifiable identifiers can be written on the cover. The preferred material for the cover will be a relatively inexpensive, yet strong, plastic material such as ABS (Acrylonitrile butadiene styrene) or the like.

Therefore, it is an object of the present invention to provide a tool holder having a plurality of receptacles and at least one cover for one of the receptacles; wherein the cover increases workplace safety and security.

It is another object of the present invention to provide a tool holder having a plurality of receptacles and a cover for at least one of the receptacles; wherein the cover protects the tool being covered.

It is yet another object of the present invention to provide a tool holder having a plurality of receptacles and a cover for at least one of the receptacles; wherein the cover is economical and improves workplace efficiency.

These and other objectives and advantages of the invention will appear more fully from the following description, made in conjunction with the accompanying drawings wherein like reference characters refer to the same or similar parts throughout the several views. And, although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include corresponding parts;

FIG. 1 is a perspective view of a tool holder 10 of the present invention including a tray 42 having a plurality of tool receptacles 52 and a plurality of covers 12 protecting tools 70 stored on the tray 42;

FIG. 2 is a plan view of the cover 12 of FIG. 1 including a body 14 having a first portion 16 and a second portion 18;

FIG. 3 is a perspective view of the cover 12 of FIGS. 1 and 2 illustrating how the cover 12 may be secured to the to the tray 42;

FIG. 4 is a perspective exploded view of the two-piece body 14 of FIG. 2 illustrating how the top, or first portion 16 may be used with either of the two shown bottom, or second portions 18, 18′;

FIG. 5 is a cross-sectional view of the cover 12 of FIG. 3 taken along line 5-5;

FIG. 6 is a partial, cross-sectional view of the cover 12 of FIG. 5 taken along line 6-6; and

FIG. 7 is a partial, cross-sectional view similar to that of FIG. 6, illustrating how, alternatively, the cover 12 may be magnetically fastened to the tray 42.

### DETAILED DESCRIPTION OF THE PREFERRED EMBODIMENTS

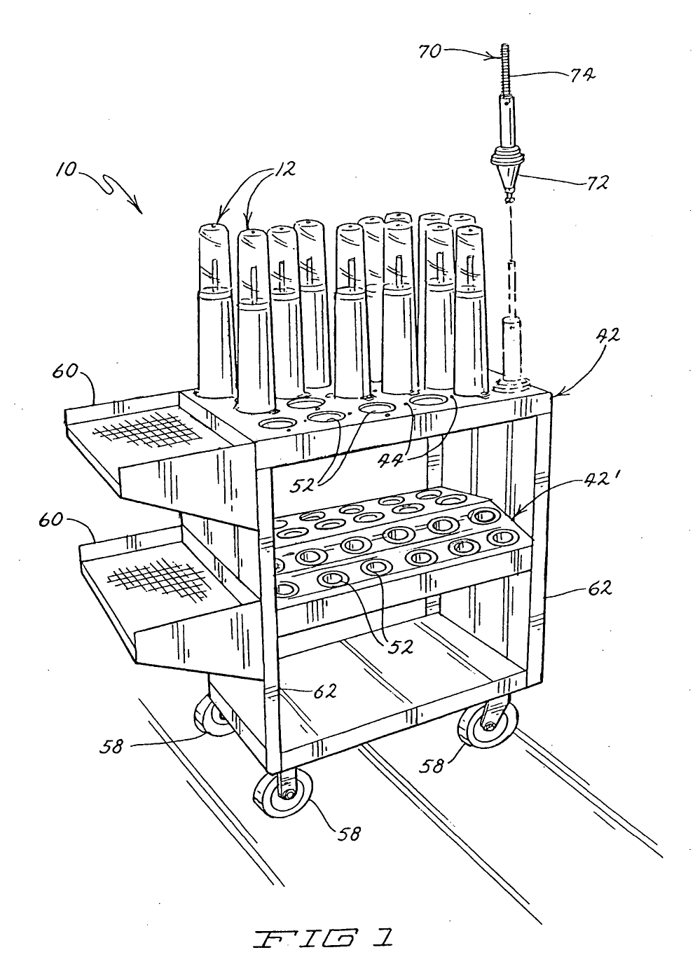

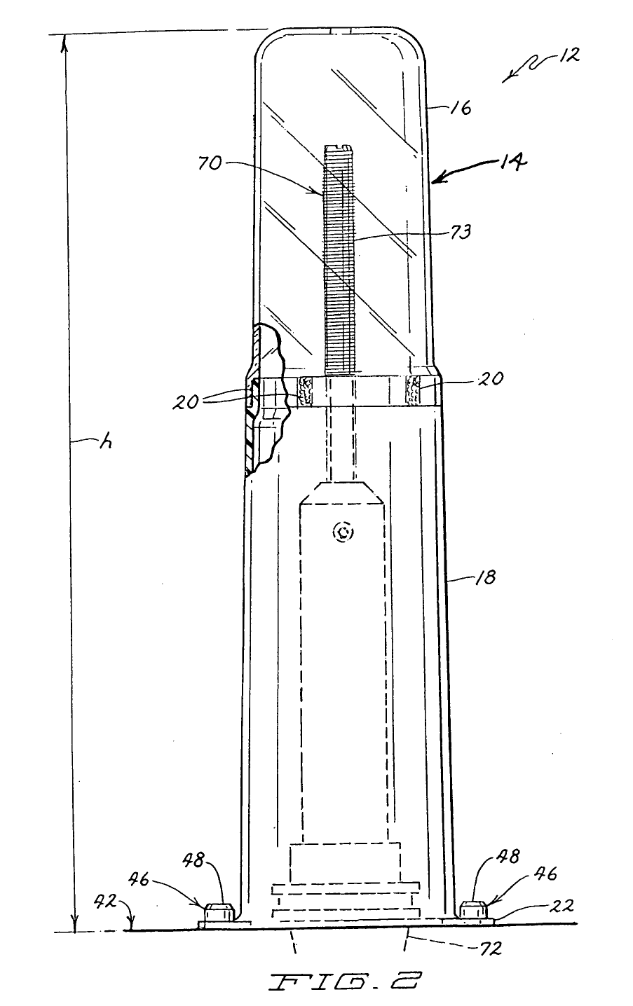

A tool holder 10 of the present invention is illustrated in FIGS. 1 and 2. The preferred tool holder 10 is a cart that includes a plurality of trays 42, 42′ that are supported by two opposing side walls 62. The tool holder 10 further includes a plurality of covers 12 secured to one of the trays 42, 42′ over one of a plurality of receptacles 52. Each tray 42, 42′ has an array of receptacles 52 for receiving a tool 70. Optionally, the tool holder 10 may further include shelves 60 that may be used to place unused covers 12, and wheels 58 that increase the mobility of the tool holder 10. In preferred embodiments including multiple trays, any tray 42′ located below top tray 42 is crowned or peaked so that any tools thereon are more accessible.

To protect the stored tools 70 and keep them clean, to protect machine operators from cutting themselves on the stored tools and also to minimize the likelihood of successful industrial espionage, a cover 12 may be placed over each tool 70 to protect the tool 70, keep it clean and hide it from clear view. In preferred embodiments, the cover 12 is removably secured over each receptacle 52 and any tool 70 so that the cover 12 is not likely to come off except the cover 12 is after deliberately removed.

It will be appreciated that there are many different CNC tools that will be held in any of the various receptacles 52. Each different tool will have a height and a width that will vary. For that reason, the various covers 12 will be required to have different height and/or widths, creating a need for multiple cover shapes. The larger the height “h” of the cover 12, the more expensive injection molding will be. Therefore, in many embodiments, a two-piece body 14 is preferred as is more economical. The preferred cover 12 includes a body 14 having a first portion 16 and a second portion 18 having a base 22, which serves as the contact point between the tray 42 and the cover 12. In this embodiment, the base 22 extends outwardly from the bottom of the second portion 18. It will be understood that a one-piece cover is within the scope of the invention, however, it is believed that a one piece construction is much more expensive, especially for tools where the height “h” is greater than about 6 inches. The tool holder 10 of the present invention is particularly useful for storing and transporting CNC tooling, which will generally require a cover of about 6 to about 16 inches in height. Therefore, as previously mentioned, a two-piece construction is more economical and therefore, preferred. The first portion 16 may be secured to the second portion 18 by sonic welding or the like. For example, as shown, the cover 12 may be sonically welded in three places 20 approximately 120 degrees from each other.

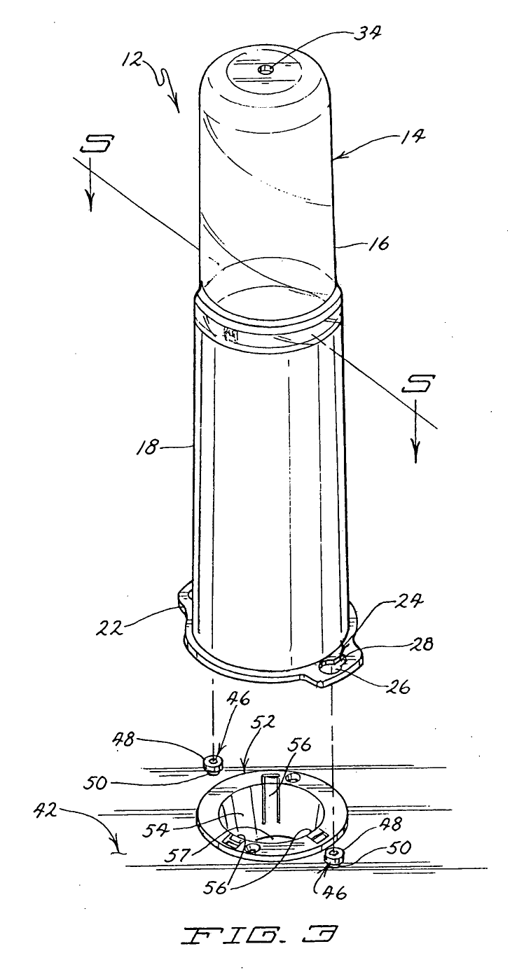

Now also referring to FIG. 3, which is a partial, exploded view of the cover 12 and one of the receptacles 52. The preferred receptacle 52 includes an opening 57 and an inner surface 54 having a plurality of catch members 56. The tool 70 will generally have a base 72 (see also FIG. 2) and a working portion 74. The tool base 72 is inserted into the receptacle 52 with the working portion 74 pointing upwards. As the tool base 72 is inserted into the receptacle 52 and partially through the opening 57, it will seat itself or “nest” in the receptacle 52. The catch members 56 grip the tray 42 and, although they are not required, generally help to retain the tool receptacle 52 within an opening (not shown) in the tray 42.

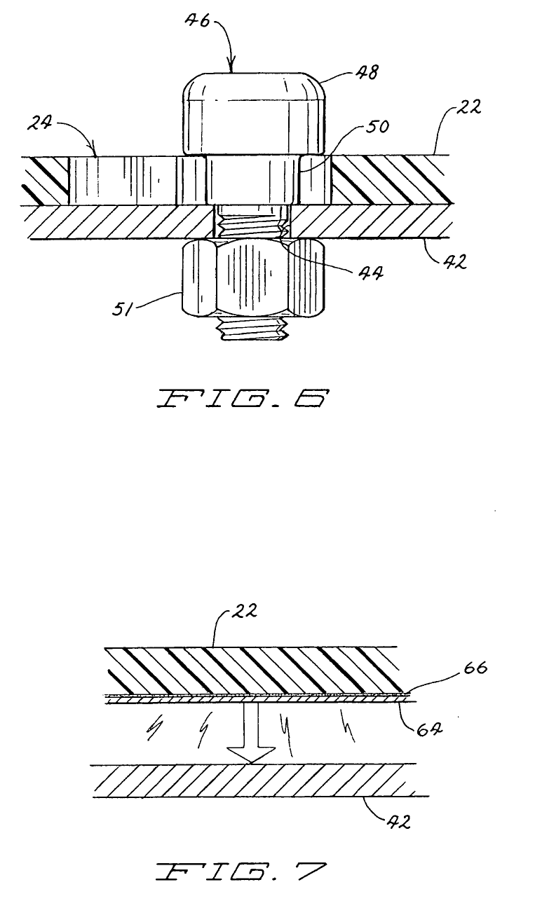

In preferred embodiments, the cover 12 is removably secured to the tray 42. In preferred embodiments, the base 22 of the cover 12 includes a first fastening element 24 that cooperates with a second fastening element 46 located on the tray 42. Illustrations of such fastening elements, such as key hole slots 24 that secure to shoulder screw or shoulder bolts 46 are shown at least in part in FIGS. 2-6. An alternate embodiment, providing magnetic fasteners 64, which attach by magnetic attraction to the tray 42, that is preferably made of steel, is shown in FIG. 6. It is noted that the shown fastening elements are only illustrative and that other are possible fastening elements or modifications of the shown fastening elements will be obvious to one of ordinary skill in the art in light of this disclosure. For example, magnets can be used as shown in FIG. 7 or removable tacky adhesive could also be used, but is not preferred.

It is also preferred that the cover 12 include a moisture equilibrium vent 34. The vent 34 prevents the buildup of moisture inside the cover 12, which can damage the tool 70. It is to be understood that the vent may be a circular aperture as shown or otherwise a slot, group of openings or the like.

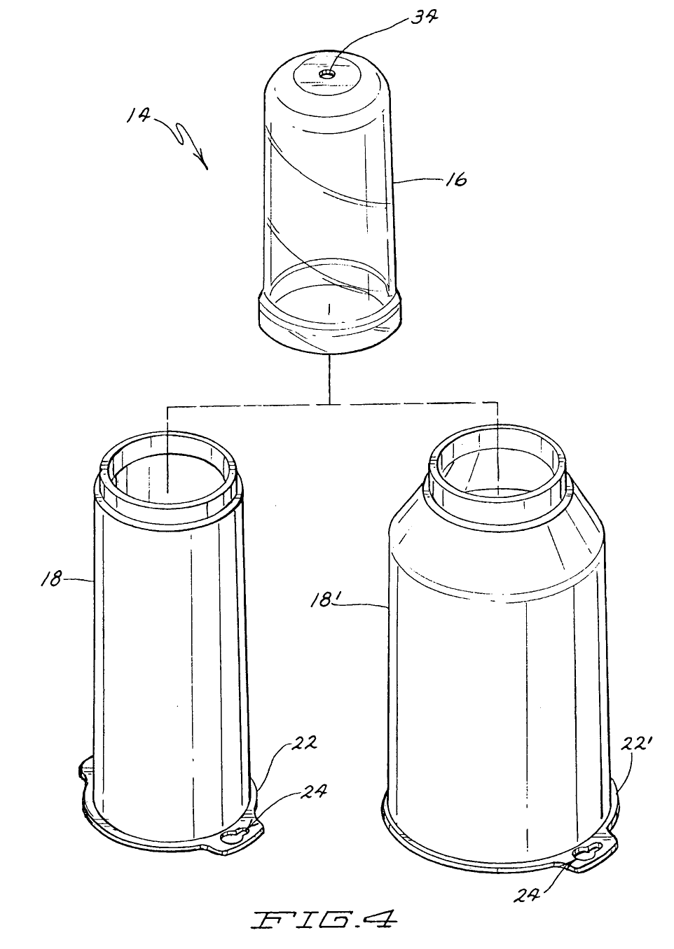

FIG. 4 illustrates two embodiments of the cover that may be used with tool holders in accordance with the present invention. The first portion 16, as also shown in FIGS. 1-3, can be connected to the second portion 18 having the base 22 with a slightly larger diameter or width than the first portion 16. An alternative second piece 18′ has a base 22′ with a significantly larger diameter than the first portion 16. It is preferable, that the first and second portions be configured so that the same first portion 16 can be connected to a variety of second portions 18, 18′ having various base 22, 22′ diameters such that less molding equipment is required and covers can be made to order. In the most preferred embodiments, the first portion 16 is translucent such that the tool 70 masked by the cover 12 may be identified at a close distance (see also FIG. 1). It is further preferred that the first portion 16 have an identifier, such as a color tint (e.g. red, orange or green), to, for example, label the condition of the tool 70. Further, in preferred embodiments, the second portion 18 is opaque to reduce the opportunity for industrial espionage by obstructing the tool 70 within the cover 12. The preferred material for the cover is a relatively inexpensive, yet strong plastic material such as ABS (acrylonitrile butadiene styrene) or the like. This material may be marked with a dry-erase marker, grease pencil or the like to further identify the contents of the cover.

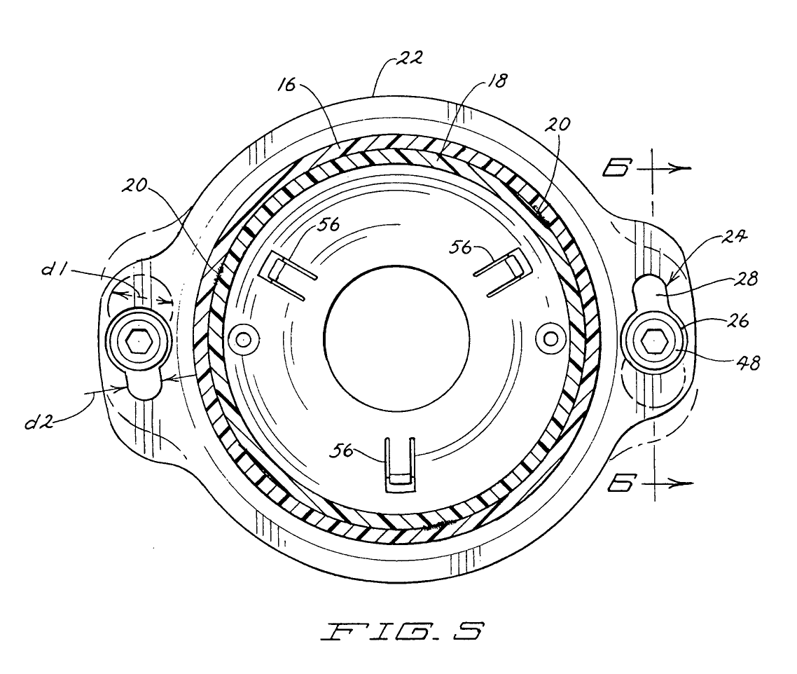

The preferred method of attaching the cover 12 to the tray 42 is further illustrated in FIGS. 5-6. The tray 42 preferably includes a pair of second fastening elements. In this embodiment, the second fastening elements are a pair of threaded shoulder screws or shoulder bolts 46 each having a head 48, a shoulder 50 and a nut 51 that secures the screw or bolt 46 in an aperture 44 in the tray 42. The base 22 preferably includes a pair of first fastening elements 24. In this embodiment, the first fastening elements are a pair of key hole slots 24 each having a first area 26 and a second area 28. Each first and second area 26, 28 having a diameter “d₁”, “d₂”, respectively. The first fastening elements 24 are arranged and configured such that first area 26 can fit over the bolt head 48 which is secured to the tray 42. In this configuration, the cover 12 may then be twisted in a counterclockwise direction until the bolt neck 50 snaps within the second area 28. To release the cover 12 from the tray 42, the cover 12 is rotated in a clockwise direction until the bolt neck 50 snaps out of the second area 28 and into the first area 26. Then the cover 12 may be lifted upwardly and off of the tool 70.

It will be appreciated that in another embodiment (not shown), the orientation of the slots could be changed so that the direction of this rotation to engage the cover and disengage the cover could be reversed.

Referring also now to FIG. 7, showing an alternate fastening method for removably securing the base 22 to the tray 42. In this embodiment, the base 22 includes a magnetic portion 64 instead of the key hole slots 24 shown in previous embodiments. In preferred embodiments, the magnetic fastener 24 is attached to the base 22 with adhesive 66. If the tray 42 is made of ferrous metal, the magnetic fastener 64 can removably retain the cover 12 in place over the receptacle 52. It will be clear to one of ordinary skill in the art that a second corresponding magnetic portion (not shown) could be secured to the tray if the tray is not made of a magnetic material.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A cover for a tool receptacle of a CNC tool holder including tray having a plurality of receptacles for storing CNC tools, the cover comprising:
a body, the body having a first portion and a second portion; the second portion having a base extending from the bottom of the second portion; the base including a first fastening element, wherein the cover can be positioned on the tray with the first fastening element to shield a CNC tool located within one of the plurality of receptacles.

2. The cover of claim 1, wherein the first portion includes a vent.

3. The cover of claim 1, wherein the fastening element is a keyhole slot including a first area having a first diameter and a second area having a second diameter; wherein the first diameter is larger than the second diameter.

4. The cover of claim 1, wherein the second portion is opaque.

5. The cover of claim 1, wherein the first portion is transparent.

6. The cover of claim 1, wherein the first portion includes an indicator.

7. The cover of claim 6, wherein the indicator is a color.

8. A tool holder for CNC tools, the tool holder comprising:
a tray having a plurality of receptacles for receiving CNC tools; and
a cover having a body, the body having a first portion and a second portion; the second portion having a base extending from the bottom of the second portion; the base including a first fastening element, wherein the cover can be positioned on the tray to shield a CNC tool located within one of the plurality of receptacles.

9. The tool holder of claim 8, wherein the tool holder is a cart having a plurality of wheels.

10. The tool holder of claim 8, wherein the first portion has a first diameter and the second portion has a second diameter; wherein the first diameter is smaller than the second diameter.

11. The tool holder of claim 8, wherein the tray includes a second fastening element; wherein the base may be removably secured to the tray by operatively connecting the first fastening element to the second fastening element.

12. The tool holder of claim 11, wherein the first fastening element is an aperture and the second fastener is a nut and a bolt.

13. The tool holder of claim 12, wherein the bolt has a shoulder.

14. The tool holder of claim 8, wherein the first portion includes a vent.

15. The tool holder of claim 9, wherein the cover includes an indicator.

16. The tool holder of claim 15, wherein the tool holder includes a plurality of covers; the indicator is a color and the color is different on at last two of the plurality of covers.

17. A method of protecting a CNC tool, the method comprising the steps of:
providing a tray having a receptacle;
further providing a cover a cover having a body, the body having a first portion and a second portion; the second portion having a base extending from the bottom of the second portion; the base including a first fastening element, wherein the cover can be positioned on the tray to shield a CNC tool located within one of the plurality of receptacles;
providing a CNC tool having a tool base and a working portion;
inserting the tool base into the receptacle such that the working portion is facing upward; and
positioning the cover over the working portion of the tool.

18. The method of claim 17, the method further comprising the step of removably securing the cover to the tray with the first fastening element.

19. The method of claim 18, wherein the tray includes second fastening element; wherein the cover is removably secured to the tray by operatively connecting the first fastening element and the second fastening element.

20. The method of claim 19, wherein the first fastening element is a key hole slot including a first area having a first diameter and a second area having a second diameter; wherein the first diameter is larger than the second diameter, wherein the second fastening element is a nut and a bolt.

21. The method of claim 20, wherein the bolt includes a neck.

22. The cover of claim 19, wherein the first portion has a smaller diameter than the second portion.
